(19) United States
(12) Patent Application Publication
(10) Pub. No.: US 2018/0357621 A1
(43) Pub. Date: Dec. 13, 2018

(54) METHODS, SYSTEMS, NETWORKS, AND MEDIA FOR COLLECTING FUNDS VIA VIRTUAL ACCOUNT NUMBERS

(71) Applicant: Mastercard International Incorporated, Purchase, NY (US)

(72) Inventors: Amarildo Gjondrekaj, Yonkers, NY (US); Benjamin M. Berger, Rye Brook, NY (US); Jennifer Lowe, Briarcliff Manor, NY (US)

(73) Assignee: Mastercard International Incorporated, Purchase, NY (US)

(21) Appl. No.: 15/976,011

(22) Filed: May 10, 2018

Related U.S. Application Data
(63) Continuation-in-part of application No. 15/621,641, filed on Jun. 13, 2017.

(51) Int. Cl. G06Q 20/10; G06Q 20/42; G06Q 20/40

(52) U.S. Cl. CPC G06Q 20/102; G06Q 20/40; G06Q 20/42

(57) ABSTRACT

An apparatus for collecting funds can include a payment processor configured to receive, from a user device, a request to collect funds for a specified purpose. The payment processor can transmit, to the user device, an authorization code for payment authorization and can determine whether a user qualifies to receive an approved amount of funds from at least one grant for the specified purpose based on one or more user attributes of the user and the specified purpose. Upon determining that the user qualifies to receive the at least one grant and in response to receiving a request from a merchant for payment, the payment processor can determine that the merchant is requesting payment for the specified purpose, request the user device to authorize payment to the merchant using the authorization code, and transmit a request to the philanthropic organization to provide the approved amount of funds to the merchant.

### CROSS-REFERENCE TO RELATED APPLICATIONS

This application is a continuation-in-part of, and claims priority to, U.S. patent application Ser. No. 15/621,641 filed on Jun. 13, 2017, which is hereby incorporated by reference in its entirety.

### BACKGROUND

The disclosed subject matter relates to methods, systems, networks, and media for collecting funds via virtual account numbers.

In developing countries, hospitals and several merchants will often refuse treatment for patients that do not have the funds to pay up front and in full. Several education institutions also require tuition to be paid in full before allowing potential students to register for classes. Because of this, many people heavily rely on family and friends to contribute to healthcare and education costs. The time, energy, and resources that it takes to collect the funds (e.g., often cash) delays medical attention and the ability to enroll in classes when it is needed most. The time that it takes to transport the funds to the hospital and educational institutions once these funds are collected also adds to the delay. Additionally, contributors may also refrain from providing funds although they want to help because they are unsure whether the contributions will be used for the requested purpose or whether the funds will be used for another purpose. For example, friends and family might have reservations about contributing funds to a potential student because they suspect that the potential student will spend the funds on frivolous expenses instead of applying it towards his or her tuition payments.

Additionally, individuals in need of collecting funds are often unaware that they could qualify for a grant offered by a non-governmental organization (“NGO”) or other philanthropic organization based on their demographic characteristics, background, and/or specific circumstances. Due to a lack of knowledge about the existence of such grants, individuals in need of funds who are perfect candidates for such NGO and/or philanthropic organization grants do not have access to such grants primarily intended for individuals like them.

Accordingly, there exists a need for improved fund collection system and process that can allow fund collection where the only method to withdraw the money is by directly paying a registered merchant in real-time for the purpose for which funds are collected.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, a computer-implemented method for collecting funds is disclosed. The computer-implemented method can include receiving, at a payment processor and from a user device, a request to collect funds for a specified purpose. The method can include transmitting, by the payment processor and to the user device, an authorization code for payment authorization and determining, by the payment processor, whether a user of the user device qualifies to receive, from at least one philanthropic organization, an approved amount of funds from at least one grant for the specified purpose based on one or more user attributes of the user and the specified purpose. Upon determining that the user qualifies to receive the at least one grant and in response to receiving a request from a merchant for payment, the method can include determining, by the payment processor, that the merchant is requesting payment for the specified purpose. The payment processor can request the user device to authorize payment to the merchant using the authorization code. The payment processor can transmit a request to the philanthropic organization to provide the approved amount of funds to the merchant.

For purpose of illustration and not limitation, the merchant can be aware of a plurality of philanthropic organizations that provide grants based on specific eligibility criteria.

For purpose of illustration and not limitation, to determine that the user qualifies to receive the at least one grant, the method can include identifying, by the payment processor, the at least one grant by performing at least one or more of the following two processes. First, the payment processor can compare the one or more user attributes of the user against the specific eligibility criteria of each grant provided by the plurality of philanthropic organizations to determine which grants the user is eligible to be awarded. Second, the payment processor can compare the specified purpose indicated in the request to collect funds from the user device against the specific eligibility criteria of each grant provided by the plurality of philanthropic organizations to determine if there exist any grants to provide funds to the user for the specific purpose. The method can include searching at least one or more databases identifying the plurality of philanthropic organizations and the specific eligibility criteria of each grant provided by each of the plurality of philanthropic organizations.

For purpose of illustration and not limitation, the one or more user attributes can be obtained by one or more of providing, by the payment processor, the user with questions to determine whether the user is a match for the specified criteria associated with different grants; and obtaining, by the payment processor, user demographic information from one or more publicly available databases.

For purpose of illustration and not limitation, the approved amount of funds can be used to pay merchants at one or more institutions that are associated with the specified purpose.

For purpose of illustration and not limitation, the user can be prevented from withdrawing the approved amount of funds.

For purpose of illustration and not limitation, the method can include determining, by the payment processor, the approved amount of funds from at least one grant for the specified purpose meets an estimated cost provided by the merchant. Upon determining that the approved amount of funds is less than the estimated cost, the payment processor can collect a remaining amount of funds from individual contributors for the specified purpose in a virtual account associated with the specified purpose and a user of the user device. The method can include transmitting, by the payment processor and to the user device, an authorization code for payment authorization and a link to share with one or more individual contributors through which funds can be collected for the specified purpose in a virtual account associated with the specified purpose and the user. In response to receiving a request from the merchant for payment, the payment processor can instruct a financial institution associated with the virtual account to transfer an amount of funds collected from the individual contributors for the remaining amount of funds in the virtual account to the merchant.

For purpose of illustration and not limitation, the method can include providing, by the payment processor, updates to the user device indicating that at least one grant is available from the at least one philanthropic organization for the specified purposed upon determining that the user qualifies to receive the at least one grant.

In accordance with another aspect of the disclosed subject matter, an apparatus for collecting funds is disclosed. An apparatus for collecting funds can include a payment processor configured to receive, from a user device, a request to collect funds for a specified purpose. The payment processor can transmit, to the user device, an authorization code for payment authorization and can determine whether a user of the user device qualifies to receive, from at least one philanthropic organization, an approved amount of funds from at least one grant for the specified purpose based on one or more user attributes of the user and the specified purpose. Upon determining that the user qualifies to receive the at least one grant and in response to receiving a request from a merchant-side processor for payment, the payment processor can determine that the merchant is requesting payment for the specified purpose, request the user device to authorize payment to the merchant using the authorization code, and transmit a request to the philanthropic organization to provide the approved amount of funds to the merchant.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is a diagram illustrating a representative payment network according to an illustrative embodiment of the disclosed subject matter.

FIG. 2 is a diagram illustrating a system for collecting funds according to an illustrative embodiment of the disclosed subject matter.

FIG. 3 is a diagram illustrating a representative method in which a payment processor can communicate with a financial institution, a user, one or more fund contributors, and a merchant to perform a representative method for collecting funds according to an illustrative embodiment of the disclosed subject matter.

FIGS. 4A-4C are diagrams illustrating representative screenshots generated at a user device according to an illustrative embodiment of the disclosed subject matter. FIG. 4D is a diagram illustrating a representative screenshot generated at a merchant terminal according to an illustrative embodiment of the disclosed subject matter.

FIG. 5 is a flow chart illustrating a representative method, for collecting funds from individual contributors, implemented according to an illustrative embodiment of the disclosed subject matter.

FIG. 6 is a flow chart illustrating a representative method, for collecting funds from a philanthropic organization, implemented according to an illustrative embodiment of the disclosed subject matter.

FIG. 7 is a block diagram illustrating further details of a representative computer system according to an illustrative embodiment of the disclosed subject matter.

Throughout the drawings, the same reference numerals and characters, unless otherwise stated, are used to denote like features, elements, components or portions of the illustrated embodiments. Moreover, while the present disclosed subject matter will now be described in detail with reference to the figures, it is done so in connection with the illustrative embodiments.

### DETAILED DESCRIPTION

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

The methods, systems, networks, and media presented herein can be used for collecting funds via virtual account numbers.

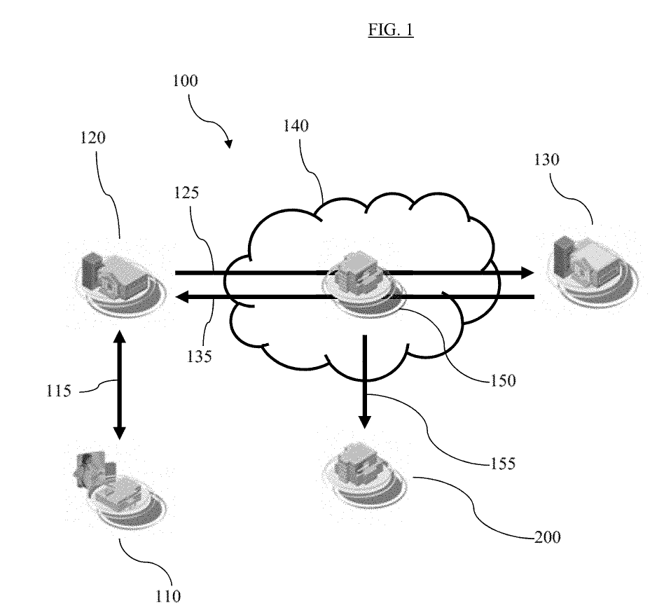

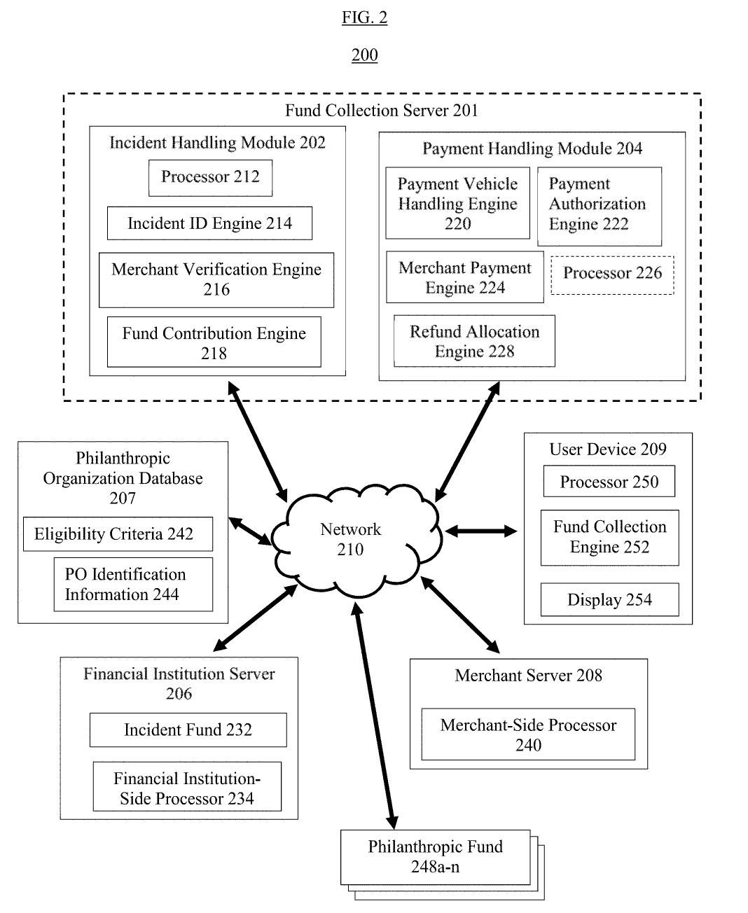

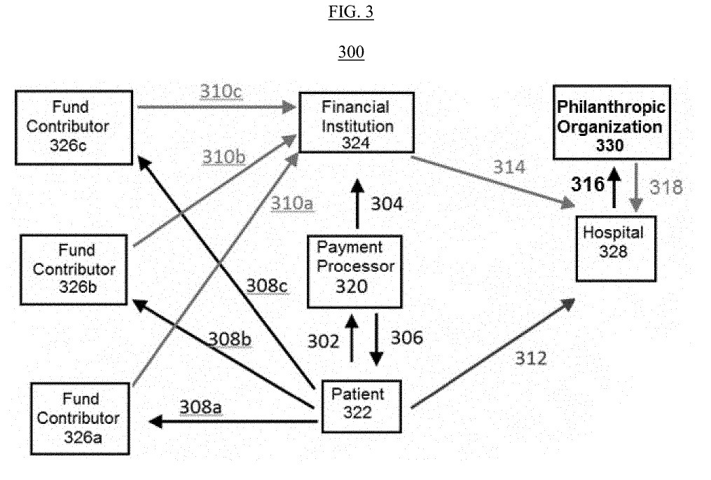

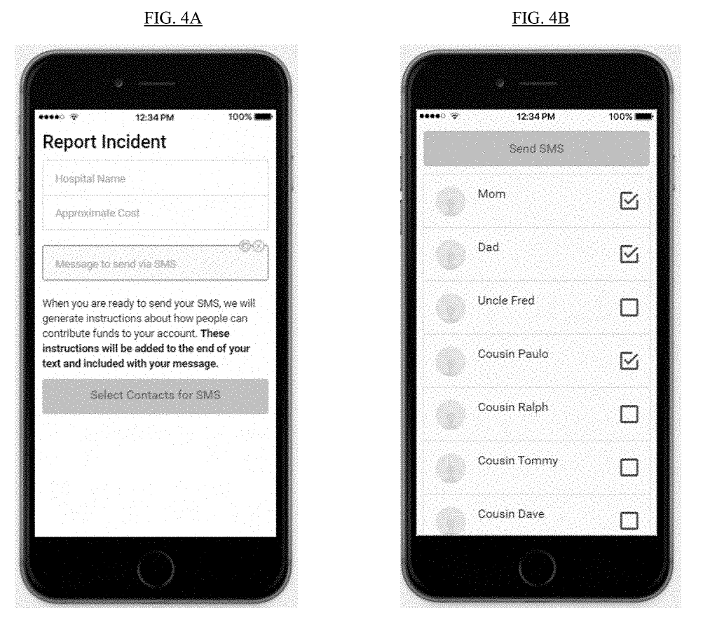

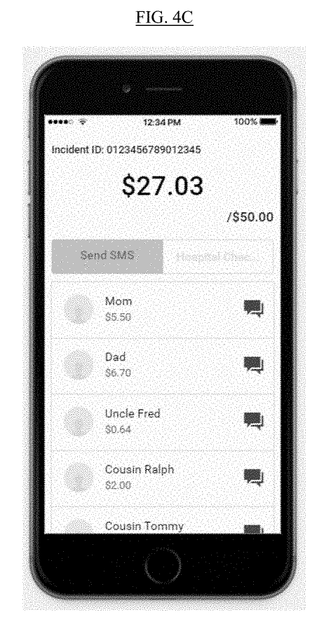

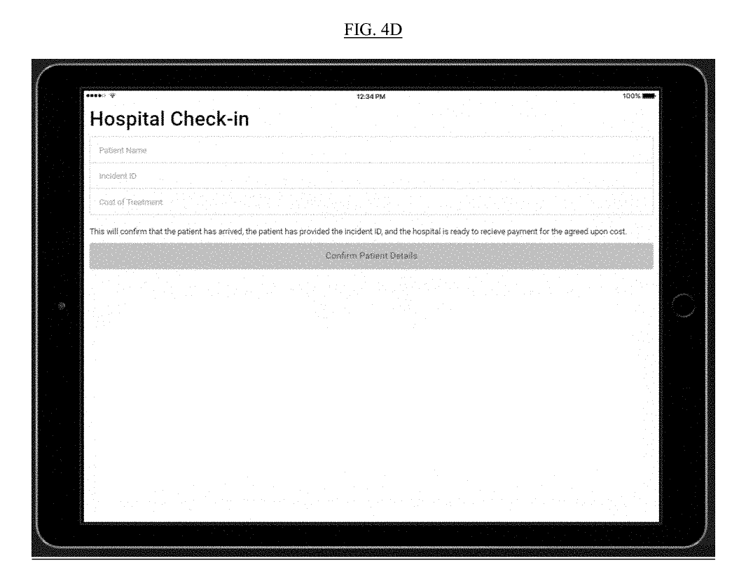

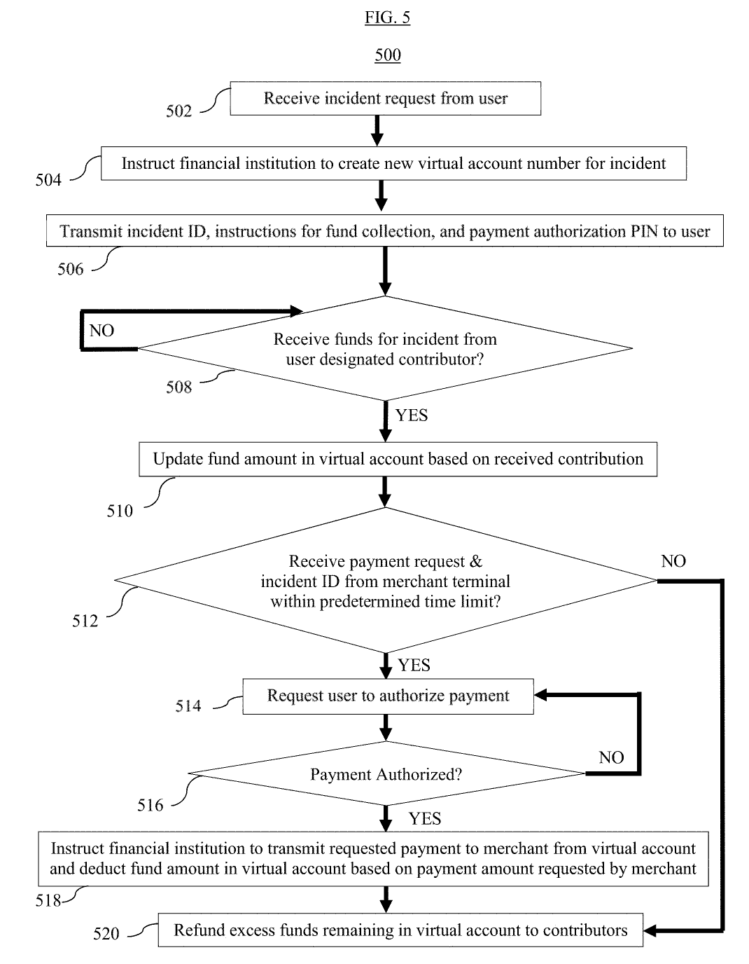

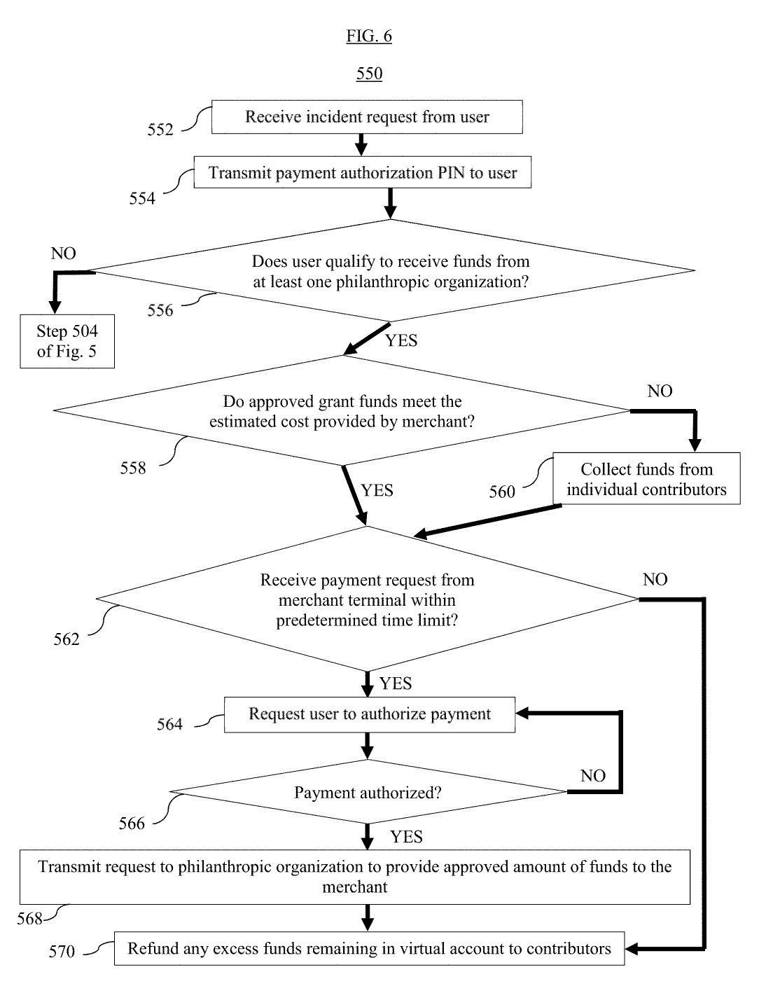

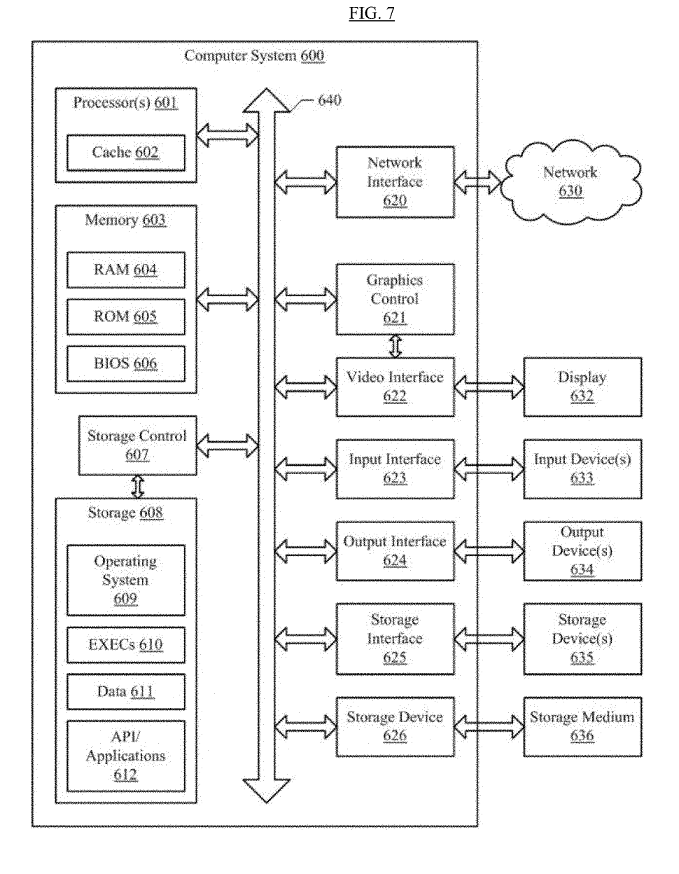

The accompanying figures, where like reference numerals refer to identical or functionally similar elements throughout the separate views, further illustrate various embodiments and explain various principles and advantages all in accordance with the disclosed subject matter. For purpose of explanation and illustration, and not limitation, an exemplary embodiment of a payment networks for collecting funds via virtual account numbers in accordance with the disclosed subject matter is shown in FIG. 1. FIG. 2 shows an exemplary block diagram of a system for collecting funds via virtual account numbers in accordance with the disclosed subject matter. FIG. 3 shows an exemplary embodiment of a method by which a payment processor can communicate with a financial institution, a user, one or more fund contributors, and a merchant to perform a representative method for collecting funds in accordance with the disclosed subject matter. FIGS. 4A-4C illustrate examples of a display generated at the user device and FIG. 4D illustrates an example of a display generated at a merchant terminal in accordance with the disclosed subject matter. FIG. 5 shows an exemplary embodiment of a method for collecting funds via virtual account numbers from individual contributors in accordance with the disclosed subject matter. FIG. 6 shows an exemplary embodiment of a method for collecting funds via virtual account numbers from philanthropic organizations in accordance with the disclosed subject matter. An exemplary embodiment of a computer system for use with the disclosed subject matter is shown in FIG. 7. While the present disclosed subject matter is described with respect to using methods, systems, networks, and media for collecting funds to treat a medical emergency, one skilled in the art will recognize that the disclosed subject matter is not limited to the illustrative embodiments. For example, the disclosed methods, systems, networks, and media for collecting funds via virtual account numbers can be used with a wide variety of non-e-commerce transaction settings, such as in-store merchant transactions, increasing customer awareness for a non-profit/charitable cause, crowd-funding, and a variety of other applications.

FIG. 1 depicts a diagram illustrating a representative payment network 100 according to an illustrative embodiment of the disclosed subject matter. Payment network 100 can allow for payment transactions in which merchants and card issuers do not necessarily have a one-to-one relationship. The payment network 100, for example and without limitation a credit card payment system, can utilize an electronic payment network 140, such as the MasterCard® payment card system interchange network. MasterCard® payment card system interchange network is a proprietary communications standard promulgated by MasterCard International Incorporated® based on the ISO 8583 message format for the exchange of financial transaction data between financial institutions that are customers of MasterCard International Incorporated. (MasterCard is a registered trademark of MasterCard International Incorporated located in Purchase, N.Y.)

As embodied herein, the payment network 100 for collecting funds can include at least one merchant 110 connected to at least one electronic payment network 140, either directly or through an acquirer 120 via connection 115. At least one acquirer 120 can be connected to the electronic network 140, and each merchant 110 can be in communication with at least one acquirer 120 via the at least one payment network 140 or connection 115. At least one issuer 130 can be connected to the electronic network 140, and each acquirer 120 can be in communication with at least one issuer 130 via the electronic payment network 140.

For purpose of illustration and not limitation, in payment network 100, a financial institution, such as an issuer 130, can issue an account, such as a credit card account or a debit card account, to a cardholder (e.g., an individual consumer or a corporate or commercial customer), who can use the payment account card to tender payment for a purchase from a merchant 110 or to conduct a transaction at an ATM or website. To accept payment with the payment account card, merchant 110 can establish an account with a financial institution that is part of the financial payment system. This financial institution can be referred to as the “merchant bank” or the “acquiring bank,” or herein as “acquirer 120.” When a cardholder tenders payment for a purchase with a payment account card, the merchant, ATM, or web site 110 can request authorization from acquirer 120 for the amount of the purchase. The request can be performed over the telephone, online via a web site, or through the use of a point-of-sale terminal which can read the cardholder's account information from the magnetic stripe on the payment account card, from a smart card using contact pads, or contactlessly from a near-field communication (NFC) device and communicate electronically with the transaction processing computers of acquirer 120. Alternatively, acquirer 120 can authorize a third party to perform transaction processing on its behalf. In this case, the point-of-sale terminal can be configured to communicate with the third party. Such a third party can be referred to as a “merchant processor” or an “acquiring processor.”

As embodied herein, using payment network 100, the computers of acquirer 120 or the merchant processor can communicate information regarding payment card transactions with computers of the issuer 130. For example and not limitation, information regarding payment card transactions can include an authorization request 125 and an authorization response 135. An authorization request 125 can be communicated from the computers of the acquirer 120 to the computers of issuer 130 to determine whether the cardholder's account is in good standing and whether the purchase is covered by the cardholder's available credit line or account balance. Based on these determinations, the authorization request 125 can be declined or accepted, and an authorization response 135 can be transmitted from the issuer 130 to the acquirer 120, and then to the merchant, ATM, or website 110. The authorization request 125 can include account information identifying the merchant, location information (e.g., an address of the merchant), and transaction information, as discussed herein. The authorization response 135 can include, among other things, a result of the determination that the transaction is approved or declined and/or information about the status of the payment card or payment account.

For example and not limitation, at least one payment network server 150 can be connected to the electronic payment network 140 and configured to automatically capture the data representing a plurality of variables related to payment card transactions from the electronic payment network 140. Additionally, the payment network server can be connected to a system 200 for predicting acceptance of a commercial card product either by the electronic payment network 140 or a separate connection 155. As embodied herein, the payment network server 150 can be configured to only capture the data representing a plurality of variables related to payment card transactions with the permission of the cardholder. Additionally, the payment network server 150 can be configured to only capture the information regarding payment card transactions in accordance with applicable data privacy laws.

FIG. 2 depicts a block diagram illustrating a representative system 200 for collecting funds according to an illustrative embodiment of the disclosed subject matter. The exemplary system 200 can include at least an incident handling module 202, a payment handling module 204, a financial institution server 206, a philanthropic organization database 207, a merchant server 208, a user device 209, and philanthropic funds 248a-n, which can all communicate with each other over network 210. Network 210 may be a wireless network, local area network, the world wide web, or any other suitable network.

In some embodiments, the incident handling module 202 and payment handling module 204 can be both a part of a fund collection server 201 and can share computing resources. For example, the processor 212 and processor 226 can be part of the same processor and/or can share processing circuitry and/or processing software. In some other embodiments, the incident handling module 202 and payment handling module 204 can be independent entities that do not share the same resources and can be located in different locations.

As embodied herein, the user device 209 can include a processor 250, a fund collection application engine 252, and a display 254. The user device 209 can be a mobile computing device (e.g., smartphone, tablet, laptop, smartwatch, wearable computing device, etc.). A user of the user device 209 can request his or her friends, family, coworkers, and any other contacts, to donate funds for a specified purpose through a fund collection application, which can be downloaded to the user device 209 from an applications store (e.g., Apple Store, Google Play, Windows Store, BlackBerry App World, Cydia, Lenovo App Store, Samsung Apps, LG Smart World, etc.). In some embodiments, the user can request funds for an emergency (e.g., injury sustained in an accident) using user device 209. In other embodiments, funds can be requested by the user of the user device 209 for non-emergency purposes (e.g., to pay tuition bills for an educational institution, to participate in a lottery, to buy particular goods or services, etc.).

In some embodiments, the user of user device 209 can request funds through a mobile application. For example, a fund collection application, which enables the user device 209 to communicate with incident handling module 202, can be downloaded onto the user device 209 from an application store. The fund collection engine 252, which can be a combination of processing circuitry and software of the user device 209 executing the fund collection application, can generate a display of the fund collection application on the user device 209's display 254 and can also communicate with incident handling module 202 to execute the fund collection application. The user can request funds to be collected for a specific purpose by submitting such a request in the fund collection application. The incident handling module 202 can communicate with the fund collection application executing on user device 209 to enable the fund collection engine 252 on user device 209 to generate display of the fund collection application on display 254.

In some embodiments, the user of user device 209 can request funds by calling and/or texting a phone number associated with an incident handling module 202 (e.g., MasterCard HealthSend server). In some embodiments, the user of the user device 209 can text a number that can provide texts, to the user device 209, providing instructions on how contributors can contribute funds to the virtual account. In some embodiments, the incident handling module 202 can provide, to the user device 209, authorization information that the user can input into a merchant terminal to authorize payments of collected funds. In other embodiments, the user of user device 209 can call an automated touchtone dial-in number associated with the incident handling module 202 that can provide, through automated audio playback, instructions on how contributors can contribute funds to the virtual account and authorization information that the user can input into a merchant terminal to authorize payments of collected funds. The incident handling module 202 can generate such texts and/or automated audio playback to provide to the user device 209.

As embodied herein, the incident handling module 202 can include a processor 212, an incident identifier (ID) engine 214, a merchant verification engine 216, and a fund contribution engine 218. Upon receiving a request from user device 209, whether through the fund collection application installed on user device 209, or receiving a call, text, and/or email from the user, the processor 212 of the incident handling module 202 can instruct the incident ID engine 214 to create a new incident ID associated with the request received from the user. The incident ID engine 214 can generate a unique incident ID and associate it with the user and with other details included in the request (e.g., time the request was received, the purpose specified in the request for which funds are to be collected, etc.). The incident ID engine 214 can be a combination of processing hardware and software that can be executed by processor 212 to create the incident ID based on information provided by the user in the request to collect funds.

In some embodiments, the merchant verification engine 216 can identify a list of merchants and/or institutions providing the goods and/or services corresponding to the specified purpose that the user has identified in the request for fund collection. For example, upon determining that the user requests that he needs emergency medical treatment for a broken leg, the merchant verification engine 216 can identify one or more hospitals and/or clinics that can provide emergency medical treatment and which are also partnered with the system 200. For example, a select list of hospitals may have partnered with the system 200 to be authorized to be compensated using the fund collection payment program provided by system 200. In some embodiments, system 200 can authorize the collected funds to be released for payment only to partner merchants and/or institutions. For example, merchant verification engine 216 can retrieve, either from local databases or from information stored in external databases, a list of merchants and/or institutions that have partnered with system 200 and/or the financial institution through which system 200 collects funds. In some embodiments, the merchant verification engine 216 can use specific codes and/or types of identifiers present in the request received from the user device 209 indicating the type of purpose specified in the request, which can be associated with the corresponding type of merchant in the information retrieved and/or accessed by the merchant verification engine 216. For example, if the user requests medical treatment for a broken leg, the fund collection application engine 252 can associate a code for medical care and/or treatment to the request, indicating that the specified purpose of the request is for medical treatment. In some embodiments, the data indicating the partner merchants and/or institutions retrieved by the merchant verification engine 216 can include and/or be assigned, by the merchant verification engine 216, such corresponding codes (e.g., a hospital can be assigned the code for medical care that corresponds to the code in the received request) for indexing and/or identification purposes. In some embodiments, such merchant verification methods can be used to prevent fraudulent misuse of collected funds at merchants and/or institutions that are not approved by a financial institution and/or other rating agency to provide the type of goods and/or services that they claim to provide. In some embodiments, such merchant verification methods can be used to prevent the users from engaging with merchants that have been known to provide low quality (e.g., falling below a certain rating threshold) of services and/or have had customer complaints and/or complaints of fraud.

In some embodiments, the incident ID can be used as an identifier that is transmitted to the user and/or the one or more contributors who donate funds without providing them with the account number of the account in which the funds are being deposited. In some embodiments, only the incident handling module 202 and/or the payment handling module 204 can identify the account number at a financial institution that corresponds to the incident ID. By enabling only the incident handling module 202 and/or the payment handling module 204 to identify the financial account information associated with incident ID and keeping the user and all other parties unaware of the account number associated with the incident ID, system 200 can prevent the user from withdrawing funds for unauthorized purposes besides the predetermined specific purpose for which funds are collected and only allow the one or more authorized merchants from being able to withdraw funds from the virtual account associated with the incident ID.

In some embodiments, once the incident handling module 202 receives the request from the user device 209 to collect funds, the incident ID engine 214, which can be operating under instructions from the processor 212, can create a virtual account and the incident ID and can associate them both together. Such an association of the virtual account at the financial institution and the incident ID can be maintained in a secure manner within the incident handling module 202 and/or the fund collection server 201. In some embodiments, the incident handling module 202 can provide instructions to the financial institution server 206, which can be located at the financial institution partnered with the fund collection server 201, to create a new virtual account in response to receiving a request to create a new incident ID and virtual account. For example, the processor 212 can instruct the financial institution-side processor 234 to create a new virtual account (e.g., incident fund 232) at the financial institution to which contributions from the fund contributors can be deposited.

In some embodiments, the incident handling module 202 can generate and transmit user authorization codes to the user device 209 and/or the user associated with user device 209. For example, upon receiving the request to collect funds from the user, the incident handling module 202 (e.g., the incident ID engine 214 operating under instructions from processor 212) can generate an encrypted PIN and/or password that can be transmitted to the user device 209 (e.g., for display within the fund collection application on the user device 209) in a secure manner. In order for the merchant associated with merchant server 208 to be successfully authorized to receive payment from the collected funds in the virtual account, the user may be required to enter the authorization code at the merchant terminal and/or an input device at the merchant in communication with the merchant server 208.

In some embodiments, the incident ID and associated virtual account in the financial institution can be generated to be active for a temporary period of time. For example, the incident ID and/or the virtual account can be generated by the incident ID engine 214 to expire after a predetermined amount of time (e.g., 10 days) after the merchant has been paid in order to ensure that the virtual account associated with the specified purpose does not remain active for a period of time after the specified purpose for which the funds are collected in the virtual account. The incident ID can act in a similar manner to a virtual card number in that it provides identifying information to the virtual account while preventing the user, contributors, or merchant from having access to and/or knowledge of the underlying virtual account number at the financial institution associated with the incident ID simply by having access to the incident ID. In some embodiments, the incident handling module 202 can be configured to generate virtual card numbers that can be used to generate one-time use payments from the virtual account associated with the incident ID. The incident handling module 202 can transmit such one-time use virtual card numbers to the user device 209 and/or the user associated with the user device 209.

In some embodiments, the fund contribution engine 218 can provide instructions to the user to distribute and/or share with the fund contributors (e.g., the user's friend, family, and/or contacts who are to contribute funds to the virtual account) in order for them to contribute funds to the virtual account. For example, the fund contribution engine 218 can generate instructions, for display in the fund collection application for how contributors can contribute funds. Fund contributors can be allowed to make deposits to the virtual account associated with the incident ID using different payment mechanisms (e.g., credit card, money transfer, wire transfer, check, electronic check, bank transfer, payment kiosk, Mastercard Send, Mastercard MoneySend, Venmo, PayPal, digital wallet (e.g., Google Wallet), Apple Pay, Square Cash, Facebook Messenger, etc.). In some embodiments, the fund contribution engine 218 can determine which types of payment vehicles and/or modes of payment are allowed for each specific incident ID and/or request based on the availability of the modes of payment in the location of the user and/or fund contributors and the modes of payments accepted by the local financial institution in the user's region. For example, the fund contribution engine 218 can determine that the user associated with a particular request and/or incident ID is located in Ghana and determine that while Square Cash and Venmo are not available as payment methods in Ghana, other forms of payment (e.g., Mastercard MoneySend, credit card, money transfer, wire transfer, check, electronic check, bank transfer, and PayPal) are available in Ghana. Accordingly, the fund contribution engine 218 can provide instructions, to the user and/or user device 209, for how fund contributors in Ghana can deposit funds into the virtual account associated with the incident ID of the user using the payment methods available locally.

In some embodiments, the fund contribution engine 218 can provide updates to the user (e.g., through the user device 209) with how much funds are currently in the user's virtual account. For example, the fund contribution engine 218 can periodically determine the amount of available funds in the incident fund 232 associated with the incident ID and can instruct the processor 250 on the user device 209 to have the fund collection engine 252 generate a display in the fund collection application on the user device 209's display 254 indicating the amount of available funds in the user's virtual account. When a fund contributor contributes funds to the incident fund 232 via the payment handling module 204, the fund contribution engine 218 can send notifications (e.g., app notifications, text messages, etc.) to the user device 209 with the total available amount in the virtual account and/or the amount that was recently contributed by the fund contributor.

As embodied herein, the payment handling module 204 can include at least a processor 226, a payment vehicle handling engine 220, a payment authorization engine 222, a merchant payment engine 224, and a refund allocation engine 228. In some embodiments, the payment handling module 204 can track funds collected from the fund contributors and can coordinate the deposits of such funds into the virtual account. For example, the payment vehicle handling engine 220, under instructions from processor 226, can coordinate the deposit of payments received in various different payment vehicles and/or modes of payment into the virtual account (e.g., incident fund 232) in the financial institution server 206. In some embodiments, the payment vehicle handling engine 220 can process the payments received from non-bank account payment sources (e.g., digital wallet, Square Cash, Venmo, Paypal, etc.) and can direct deposit the processed payments from such alternative payment sources as deposits into the virtual account (e.g., incident fund 232) in the financial institution server 206 as a direct deposit. For example, in some embodiments, when a fund contributor chooses to contribute funds through Venmo, the payment vehicle handling engine 220 can receive the funds received through Venmo, deposit the received Venmo funds into a credit account, and direct deposit the corresponding received credit amount to the financial institution server 206 (e.g., functioning as a clearinghouse). The payment vehicle handling engine 220 can be configured to detect which payment method (e.g., credit card, money transfer, wire transfer, check, electronic check, bank transfer, payment kiosk, Venmo, PayPal, digital wallet (e.g., Google Wallet), Apple Pay, Square Cash, Facebook Messenger, etc.) is used by the fund contributor to transmit their contribution amount. The payment vehicle handling engine 220 can initiate processes to handle receiving the funds received through that payment method and deposit a corresponding amount of funds to the financial institution server 206's incident fund 232. In some embodiments, the fund contributions received from fund contributors can be accompanied with a message and/or metadata identifying the incident ID that was distributed to the fund contributor by the user with instructions on how to contribute funds. Processor 226 can identify which incident fund 232 is associated with the particular incident ID of a given fund contributor's contributions. For example, the payment handling module 204 can maintain a database of incident IDs generated by the incident ID engine 214 and their corresponding virtual accounts (e.g., incident fund 232) generated in the financial institution server 206. Upon identifying the destination virtual account associated with the received contribution and receiving the funds by handling payment from the payment method chosen by the fund contributor, the payment handling engine 220 can deposit the corresponding amount of funds as a direct deposit into the virtual account at the financial institution server 206.

In some embodiments, the payment handling module 204 can process payments to the merchants and/or institutions and can also coordinate the payment authorization with users at the merchant location. When the user has arrived at the merchant and/or institution (e.g., a merchant that is partnered with the system 200 and/or the fund collection server 201), the merchant can initiate a request for payment from the payment handling module 204. For example, the payment handling module 204 can receive a payment request from the merchant server 208. In response to receiving such a payment request, the payment authorization engine 222 can send a query to the merchant-side processor 240 at the merchant server 208 to have the user enter their authorization code which was previously sent to the user and/or the user device. The merchant server 208 can be associated with a kiosk and/or a device located at the merchant through which the user can enter their authorization code to authorize the merchant's request for payment to the payment handling module 204. In some other embodiments, in response to receiving a payment request from the merchant server 208, the payment authorization engine 222 can send a query to the user device 209 to have the user enter their authorization code instead of having the user enter the authorization code at the merchant kiosk and/or device associated with the merchant server 208.

In some embodiments, the payment handling module 204 can verify whether the merchant and/or institution is a legitimate merchant and has a bank account capable of receiving funds. For example, the merchant payment engine 224 can determine whether the merchant has partnered with the fund collection engine 201 and/or the system 200 to determine if the merchant has been vetted to be a legitimate merchant and has been guaranteed to not be a fraudulent entity. Additionally and/or alternatively, the merchant payment engine 224 can identify the bank account capable of receiving funds associated with the merchant requesting payment. For example, once a merchant has registered and/or partnered with the fund collection server 201 and/or the system 200, the merchant can be granted access to a bank account capable of receiving funds and/or have its preexisting bank account that is capable of receiving funds registered with the fund collection server 201 and/or the system 200. Such a merchant bank account can be accessed via a software application on a computing device (e.g., merchant server 208) located at the merchant's location, hereinafter also referred to as a merchant kiosk.

In some embodiments, the merchant payment engine 224 can determine whether there are sufficient funds in the user's virtual account to pay the merchant the requested amount. For example, the merchant payment engine 224 can determine the total amount of funds that have been deposited by contributors into the user's virtual account (e.g., incident fund 232). In some embodiments, upon determining that the amount of deposited funds available in the user's virtual account is less than the amount requested by the merchant, the payment handling module 204 can instruct the incident handling module 202 to prompt the user to send an urgent request to preexisting and/or additional fund contributors to donate funds immediately in order for the total amount of funds in the virtual account to at least satisfy the requested amount by the merchant. In some embodiments, upon determining that the amount of deposited funds available in the user's virtual account is less than the amount requested by the merchant, the payment handling module 204 can transmit a message to the merchant (e.g., through the merchant-side processor 240 at the merchant kiosk) that the user does not have sufficient funds to be able to pay the requested amount and can indicate the total amount of available funds in the user's virtual account along with an option to the merchant to accept the lower amount that is available in the user's virtual account. Upon determining that the merchant accepts payment of the lower amount, the merchant can be provided a subsequent option to request additional payment at a future time for the balance amount and upon determining that the merchant selects such an option, the merchant payment engine 224 can send a message to the user device 209 to raise and/or collect the balance amount by the requested future time. Upon determining that the amount of available funds is equal to or exceeds the requested payment amount by the merchant, the merchant payment engine 224 can transmit payment to the merchant. For example, the merchant payment engine 224 can identify the bank account associated with the merchant server 208 and can instruct the financial institution server 206 to transmit the requested funds from the incident fund 232 associated with the incident ID of the user.

In some embodiments, the payment handling module 204 can process refunds to be issued to the fund contributors. For example, the refund allocation engine 228 can determine after a payment has been made to the merchant's bank account, the balance amount remaining in the user's virtual account (e.g., incident fund 232). If there is a nonzero balance remaining in the user's virtual account, the refund allocation engine 228 can refund each contributor a refund amount that is proportionate to the percentage of the total contribution made in the incident fund that was raised by that particular contributor's contribution. For example, if contributor A provided 20% of the total amount of funds in the incident fund 232, the refund allocation engine 228 can refund 20% of the balance to contributor A. In some embodiments, the refund allocation engine 228 can provide refunds to each contributor using the same payment vehicle and/or method of payment that particular contributor used to contribute funds (e.g., credit card, money transfer, wire transfer, check, electronic check, bank transfer, payment kiosk, Venmo, PayPal, digital wallet (e.g., Google Wallet), Apple Pay, Square Cash, Facebook Messenger, etc.) by coordinating with the payment vehicle handling engine 220. In some embodiments, the refund allocation engine 228 can provide direct deposits of the refund amount to each contributor if the contributor and/or the user has provided bank account information for that contributor to which refunds should be deposited.

In some embodiments, in addition to collecting funds from individual contributors, funds can also be collected for the user's specific request from one or more philanthropic organizations that have funds available for such cases. While users may not be aware of every single philanthropic organization (“PO”) or whether they are eligible for such funds, the fund collection server 201 and/or the merchant server may have access to information identifying philanthropic organizations and their eligibility criteria for providing funds. Such philanthropic organizations can include non-government institutions (“NGOs”), private charities and/or memorial funds, humanitarian organizations, private donors, and/or relief organizations, any other organizations and/or individuals that have set up funds to donate money to individuals meeting specific eligibility criteria. A philanthropic organization database 207 can include a list of such PO identification information 244 that identifies the philanthropic organizations providing such funds, their contact information, and information identifying the financial institution and account number at which such funds are stored. The philanthropic organization database 207 can also include eligibility criteria 242 associated with each identified philanthropic organization. This database 207 can be created by searching through publicly available information and/or multiple different physical and/or electronic databases and retrieving PO identification information 244 and eligibility criteria 242 for each philanthropic organization.

In some embodiments, philanthropic funds 248a-n associated with each of the identified philanthropic organizations identified in philanthropic organization database 207 can be requested by the fund collection server to disburse funds to the merchant server 208. Philanthropic organization funds 248a-n can be bank accounts and/or funds located at various different financial institutions as identified by the PO identification information 244. In some embodiments, the fund collection server 201 can contact the financial institutions at which such funds are stored and instruct the financial institutions to disburse funds to the merchant server 208 once the funds have been authorized to be disbursed by the philanthropic organization and/or the merchant.

In some embodiments, the fund collection server 201 can generate user profiles for each user associated with a user device that creates a fund collection request. User attributes can include demographic information and various other types of information related to the income level, spending, insurance, education, preferences, etc. of the user. The fund collection server 201 can search through user attributes in each user profile against the eligibility criteria 242 for each philanthropic organization to determine if the user qualifies for a grant. The fund collection server 201 can obtain such user attributes through several techniques. For example, the fund collection server 201 can obtain such user attributes by providing the user with questions to determine whether the user is a match for the specified criteria associated with different grants. In some embodiments, fund collection server 201 can obtain such user attributes by retrieving user demographic information from one or more publicly available databases (e.g., government ID databases, social media, etc.).

FIG. 3 is a diagram illustrating a representative method 300 in which a payment processor 320 can communicate with a financial institution 324, a user (e.g., patient 322), one or more fund contributors 326a-c, and a merchant (e.g., hospital 328) to perform a representative method for collecting funds according to an illustrative embodiment of the disclosed subject matter. According to the embodiment illustrated in FIG. 3, the payment processor 320 can correspond to the fund collection server 201 (e.g., including incident handling module 202 and payment handling module 204) of FIG. 2. Patient 322 can correspond to the user associated with user device 209 of FIG. 2. Financial institution 324 can correspond to the financial institution associated with financial institution server 206 of FIG. 2 at which patient 322's virtual account is maintained. Hospital 328 can correspond to the merchant associated with merchant server 208 of FIG. 2. Fund contributors 326a-c are the contributors that contribute funds to patient 322's virtual account for the specified purpose. To provide a real-world application of the disclosed subject matter, in the example of FIG. 3, the patient 322 has become injured in an accident and has broken his arm. The patient 322 needs to go to a hospital (e.g., hospital 328) to treat his injury and accordingly, needs to collect funds from his friends and family (e.g., fund contributors 326a-c) to be pay for his treatment at the hospital 328. In addition to fund contributors 326a-c, funds can also be collected from one or more philanthropic organizations such as philanthropic organization 330.

At step 302, the patient 322 can report the incident (e.g., he broke his arm and needs to raise funds for treatment) to the payment processor 320. For example, patient 322 can use his smartphone (e.g., user device 209 of FIG. 2) to create a request for collecting funds to receive medical treatment. Such a request can be transmitted to the payment processor 320 along with information regarding the specified purpose for which funds are to be collected (e.g., medical treatment for injured arm).

At step 304, the payment processor 320 can create the incident ID and a virtual account with the financial institution 324. For example, as described in FIG. 2, the incident handling module 202 can create a unique incident ID associated with the user and can instruct the financial institute-side processor 234 to create a virtual account. The payment processor 320 can associate the newly created virtual account with the newly created incident ID. The payment processor 320 can store an association of the newly created virtual account and the incident ID in a local database without sharing such an association with the user, fund contributors, or third parties to prevent anyone besides the system from accessing the virtual account and withdrawing collected funds for any purpose outside the scope of the specified purpose (e.g., medical treatment for patient 322's injured arm). The payment processor 320 can also receive a selection of a hospital 328 from the patient 322 and can determine if the hospital 328 is a registered merchant with the payment processor 320. Upon determining that the hospital 328 is a registered merchant with payment processor 320, the payment processor can proceed with hospital 328 as the designated hospital for receiving treatment. However, if the payment processor 328 determines that the hospital selected by the patient 322 is not registered with the payment processor 320, the payment processor 320 can suggest alternative hospitals near the patient 322's location that have partnered with the payment processor 320 so that the patient 322 is informed which hospitals will accept funds that are raised using the disclosed subject matter's methods and systems.

At step 306, the payment processor 320 can transmit, to patient 322, the incident ID and instructions to distribute to fund contributors 326a-c on how to deposit funds into patient 322's virtual account. For example, the incident handling module 202 can transmit the incident ID, an authorization code to be used at the merchant 328, and instructions to distribute to fund contributors 326a-c on how to use different payment methods accepted in the patient 322's and/or the fund contributors 326a-c's geographic region to contribute funds to the user's virtual account. The payment processor 320 can transmit such information either by text message to the user device 209 of patient 322 and/or can instruct the processor 250 of user device 209 to generate a display within a fund collection application to display such information.

At steps 308a, 308b, and 308c, the patient 322 can contact fund contributors 326a, 326b, and 328c, respectively, with instructions on how to deposit funds to the virtual account. For example, the patient 322 can contact his/her contacts (e.g., locally stored contacts on the user device and/or other contacts) through the fund collection application, email, text, in-person, and/or any means of communication and communicate the incident ID and instructions received from payment processor 320 on how to deposit funds into the virtual account using the incident ID via the payment processor 320.

At steps 310a, 310b, and 310c, the fund contributors 326a, 326b, and 328c, respectively, can contribute funds to the virtual account at the financial institution 324 via the payment processor 320. For example, the payment processor 320 can receive, from each of the contributors 326a, 326b, and 328c, the incident ID and funds from one of the various payment methods (e.g., credit card, money transfer, wire transfer, check, electronic check, bank transfer, payment kiosk, Venmo, PayPal, digital wallet (e.g., Google Wallet), Apple Pay, Square Cash, Facebook Messenger, etc.). The payment processor 320 can deposit those received funds into the incident fund 232 associated with incident ID at the financial institution server 206 of the financial institution 324.

At step 312, the patient 322 can check into the hospital 328's location and the price that the hospital 328 will charge the patient 322 for the product and/or service can be determined. For example, the patient 322 can check into the hospital 328 for the specified purpose of receiving medical treatment for his injury and upon check-in, the hospital 328 can determine the cost to treat the injury of patient 322. The hospital 328 can send a payment request to payment processor 320 to authorize payment. In response, the payment processor 320 can request the patient 322 to enter the authorization code provided earlier to him to authorize payment of the requested amount.

At step 314, the payment processor 320 can instruct the financial institution 324 to provide the requested amount of funds to the hospital 328. Once the patient 322 has authorized payment, the payment processor can instruct the financial institution-side processor 234 at the financial institution 324 to provide the amount, from the patient 322's virtual account, that is requested by the hospital 328 to the hospital 328's bank account via the merchant server 208.

In some embodiments, the payment processor 320 can determine or instruct the hospital 328 to determine whether the patient 322 qualifies for grants from a philanthropic organization for the specified incident (e.g., broken limb). The payment processor 320 can search or instruct the hospital 328 to search a philanthropic organization database that includes information on the eligibility criteria for various different grants that the user may qualify for. Once it is determined that the patient does qualify for grants, at step 316, the hospital 328 can request payment from the philanthropic organization once the user approves the payment request upon checking in to the hospital (e.g., by using his PIN). At step 318, the philanthropic organization can transfer the approved amount of funds for which the patient 322 qualifies to the hospital 328.

FIGS. 4A-4C are diagrams illustrating representative screenshots generated at a user device according to an illustrative embodiment of the disclosed subject matter. FIG. 4D is a diagram illustrating a representative screenshot generated at merchant terminal according to an illustrative embodiment of the disclosed subject matter.

FIG. 4A illustrates an exemplary diagram of a screen display on a user device (e.g., user device 209) to allow the user to report an incident (e.g., the specified purpose). As illustrated in FIG. 4A, the patient 322 can enter the name of a merchant, which the payment processor can check to see whether it is registered with the payment processor's system, an estimated cost, and a message to send to his/her contacts to contribute funds for the specified purpose.

FIG. 4B illustrates an exemplary diagram of a screen display on a user device to allow the user to select which contacts to contact to request fund contributions for the incident reported in the screen of FIG. 4A. As illustrated in FIG. 4B, the patient r 322 can select the contacts stored in the user device 209 (e.g., the user's mobile phone) to request to contribute funds. Once the user has finalized selection of his/her contacts to which the request to contribute funds will be sent, the mobile application executing on the user device 209 can transmit the request to these selected contacts along with the incident ID and instructions for transmitting funds using one of several different payment methods (e.g., credit card, money transfer, wire transfer, check, electronic check, bank transfer, payment kiosk, Venmo, PayPal, digital wallet (e.g., Google Wallet), Apple Pay, Square Cash, Facebook Messenger, etc.).

FIG. 4C illustrates an exemplary diagram of a screen display on a user device indicating the amount of funds contributed by each fund contributor and the total amount of funds raised in the virtual account. As illustrated in FIG. 4C, as the fund contributors deposit funds via the payment processor 320 to the user's virtual account, the fund collection application on the user device depicted in FIG. 4C can keep track of each contributor's contributions and can keep track of the total amount of funds contributed to date. The fund collection application can also display the goal amount to be raised and the incident ID on such a display, as illustrated in FIG. 4C. The fund collection application can also include an option (e.g., button) next to each fund contributor's name to send them a message (e.g., to thank them and/or to request additional contributions).

FIG. 4D illustrates an exemplary diagram of a screen display on a merchant kiosk and/or merchant terminal in which the merchant can enter the user name and incident ID provided by the user upon checking into the merchant's location and in which the merchant can enter the price of the goods and/or services to be provided to the user for the specified purpose associated with the incident ID. As illustrated in FIG. 4D, the merchant kiosk can display a form in which the patient 322 can enter the incident ID while the merchant 328 can enter the name of the user and the cost. At this merchant kiosk, the merchant can also enter their institution ID in addition to the incident ID. Once such information has been entered into the merchant kiosk, a completed request for payment can be sent to the payment processor 320, which can in response initiate a payment authorization process requesting the patient r 322 to enter the authorization code into the merchant kiosk.

FIG. 5 is a flow chart illustrating a representative method 500, for collecting funds, implemented according to an illustrative embodiment of the disclosed subject matter. The exemplary network 100 of FIG. 1, system 200 of FIG. 2, and flow chart 300 of FIG. 3, and diagrams of FIG. 4A-4D, for purpose of illustration and not limitation, are discussed with reference to the exemplary method 500 of FIG. 5.

As embodied herein, at 502, the payment processor can receive an incident request from the user. For example, the patient 322 can request funds to be collected for a specific purpose by submitting such a request in the fund collection application. The incident handling module 202 can communicate with the fund collection application executing on user device 209 to enable the fund collection application engine 252 on user device 209 to generate display of the fund collection application on display 254. Upon receiving a request from user device 209, the processor 212 of the incident handling module 202 can instruct the incident ID engine 214 to create a new incident ID associated with the request received from the user. The incident ID engine 214 can generate a unique incident ID and associate it with the user and with other details included in the request (e.g., time the request was received, the purpose specified in the request for which funds are to be collected, etc.).

At 504, the payment processor can instruct the financial institution-side processor to create a new virtual account for the incident reported by the user. For example, processor 212 can instruct the financial institution-side processor 234 to create a new virtual account (e.g., incident fund 232) at the financial institution to which contributions from the fund contributors can be deposited. The payment processor can associate the virtual account and the incident ID together and store such an association locally.

At 506, the payment processor can transmit, to the user device, the incident ID, instructions for fund collection to distribute to the fund contributors, and at least one payment authorization code for payment authorization at the merchant location. For example, the fund contribution engine 218 can generate instructions, for display in the fund collection application, for how fund contributors can contribute funds. Fund contributors can be allowed to make deposits to the virtual account associated with the incident ID using different payment mechanisms (e.g., credit card, money transfer, wire transfer, check, electronic check, bank transfer, payment kiosk, Venmo, PayPal, digital wallet (e.g., Google Wallet), Apple Pay, Square Cash, Facebook Messenger, etc.).

At 508, the payment processor can determine whether funds have been received for the incident ID from a user-designated fund contributor. For example, the payment processor can monitor the virtual account (e.g., the incident fund 232) and monitor the deposit amount. Additionally or alternatively, the payment vehicle handling engine 220 can determine whether a fund contributor has provided a contribution using one of several acceptable payment methods. The method 500 can remain at this step until a payment has been received from a fund contributor corresponding to the particular incident ID.

At 510, in response to determining that funds have been received for the incident ID from a fund contributor, the payment processor can update the fund amount in the virtual account based on the contribution received from the fund contributor. For example, the payment vehicle handling engine 220 can process the payments received from non-bank account payment sources (e.g., digital wallet, payment kiosk, Square Cash, Venmo, Paypal, etc.) and can direct deposit the processed payments from such alternative payment sources as deposits into the virtual account (e.g., incident fund 232) in the financial institution server 206 as a normal direct deposit. Processor 226 can identify which incident fund 232 is associated with the particular incident ID of a given fund contributor's contributions. Upon identifying the destination virtual account associated with the received contribution and receiving the funds by handling payment from the payment method chosen by the fund contributor, the payment handling engine 220 can deposit the corresponding amount of funds as a direct deposit into the virtual account at the financial institution server 206.

At 512, the payment processor can determine whether a payment request and incident ID has been received from a merchant terminal within a predetermined time limit since the incident request was received from the user at 502. For example, the payment handling module 204 can determine whether a request from merchant server 208 to provide payment for the specified purpose occurs within a predetermined amount of time since the time of receipt of the request to collect funds from the user. The payment processor can be programmed to calculate such a predetermined amount of time based on the type of specified purpose. For example, the predetermined amount of time for medical treatments to an injury incurred with an accident can have shorter lengths of predetermined time periods than, for example, the request for tuition payments. If no such request has been received from the merchant within this predetermined amount of time, the method 500 can proceed to step 520 and refund all available funds in the virtual account to the original fund contributors. For example, if the patient 322 dies on the way to the hospital from the injury after having submitted the request to collect funds and the hospital 328 never charges the payment processor 320 for such treatment because the patient 322 died on the way to the hospital, after the predetermined time since the user request has lapsed, the payment processor 320 can refund the collected funds to the contributors.

At 514, in response to determining that payment request and incident ID have been received from the merchant terminal within the predetermined amount of time since the user request was received at 502, the payment processor can request the user to authorize payment of the requested amount to the merchant. For example, in response to receiving such a payment request, the payment authorization engine 222 can send a query to the merchant-side processor 240 at the merchant server 208 to have the user enter their authorization code which was previously sent to the user and/or the user device. The merchant server 208 can be associated with a kiosk and/or a device located at the merchant through which the user can enter their authorization code to authorize the merchant's request for payment to the payment handling module 204. In some other embodiments, in response to receiving a payment request from the merchant server 208, the payment authorization engine 222 can send a query to the user device 209 to have the user enter their authorization code instead of having the user enter the authorization code at the merchant kiosk and/or device associated with the merchant server 208.

At 516, the payment processor can determine whether payment was authorized by the user. For example, the payment authorization engine 222 can check the incident ID and the authorization code entered at the merchant kiosk that was transmitted by the merchant side-processor and compare that authorization code with the authorization code that the incident handling module 202 had sent to the user device 209 associated with the corresponding incident ID at the time of the user request to collect funds. If the authorization codes match, the payment processor can authorize payment to the merchant. If the authorization codes do not match, the method 500 can revert back to step 514 and the payment processor can query the merchant-side processor 240 to have the user enter their authorization code again correctly.

At 518, in response to determining that the user has authorized payment to the merchant for the requested amount, the payment processor can instruct the financial institution-side processor to transmit the requested payment amount to the merchant-side processor from the virtual account and deduct the payment amount from the total fund amount in the virtual account.

At 520, the payment processor can refund the excess funds remaining in the virtual account to the fund contributors. Upon determining that there is a nonzero balance remaining in the patient 322's virtual account, the refund allocation engine 228 can provide each fund contributor 326a-c with a refund amount that is proportionate to the percentage of the total contribution made in the incident fund that was raised by that particular contributor's contribution. For example, if fund contributor 326a provided 20% of the total amount of funds in the incident fund 232, the refund allocation engine 228 can refund 20% of the balance to contributor 326a.

FIG. 6 is a flow chart illustrating a representative method 550, for collecting funds, implemented according to an illustrative embodiment of the disclosed subject matter. The exemplary network 100 of FIG. 1, system 200 of FIG. 2, and flow chart 300 of FIG. 3, diagrams of FIG. 4A-4D, and flow chart of FIG. 5 for purpose of illustration and not limitation, are discussed with reference to the exemplary method 550 of FIG. 6.

As embodied herein, at 552, the payment processor can receive an incident request from the user. For example, the patient 322 can request funds to be collected for a specific purpose by submitting such a request in the fund collection application. The incident handling module 202 can communicate with the fund collection application executing on user device 209 to enable the fund collection application engine 252 on user device 209 to generate display of the fund collection application on display 254.

At 554, the payment processor can transmit, to the user device, at least one payment authorization code for payment authorization at the merchant location. For example, the payment processor 320 can transmit to the user device of the patient 322 an authorization message/token that can be submitted by the user at the merchant location (e.g., hospital 328) upon check-in for the user to authorize payment to the merchant.

At 556, the payment processor can determine whether the user qualifies to receive funds from at least one philanthropic organization. For example, the payment processor can either search philanthropic organization database 207 and/or instruct a merchant-side processor 240 having access to the philanthropic organization database 207 to determine if the user qualifies to receive funds from at least one philanthropic organization. The philanthropic organization database 207 can include identification information 244 for various philanthropic organizations and the eligibility criteria 242 for qualifying for their respective grants. The payment processor can search user attributes (i.e., which can be stored in a user profile accessible to the payment processor) of the user against the specific eligibility criteria of each grant provided by the philanthropic organizations to determine which grants the user is eligible to be awarded. For example, the payment processor can search the various philanthropic organization grants' eligibility criteria to see if there exists a grant to provide medical treatment to someone having the user's demographic criteria (e.g., race, gender, age, etc.). Additionally or alternatively, the payment processor can compare the specified purpose indicated in the request to collect funds from the user device against the specific eligibility criteria of each grant provided by the plurality of philanthropic organizations to determine if there exist any grants to provide funds to the user for the specific purpose. For example, the payment processor can search the various philanthropic organization grants' eligibility criteria to see if there exists a grant to fund someone who has broken their arm. In some embodiments, the processor can transmit updates to the user device for display on the user device indicating that at least one grant is available from at least one philanthropic organization for the specified purposed upon determining that the user qualifies to receive the at least one grant.

In response to determining that the user does not qualify to receive funds from at least one philanthropic organization, the payment processor can proceed to step 504 of the flow chart of FIG. 5 to instruct the financial institution-side processor to create a new virtual account for the incident reported by the user and proceed with collecting funds from the individual contributors.

At 558, in response to determining that the user qualifies to receive funds from at least one philanthropic organization, the payment processor can determine whether the approved grant funds meet the estimated cost provided by the merchant. The payment processor can identify the amount of funds that the philanthropic organization approves for the user's particular incident associated with the request. If one or more philanthropic organizations' eligibility criteria match the user's incident and/or other parameters, the payment processor can collect money from multiple philanthropic organizations' grants if no single grant can cover the entire amount requested by the user. If multiple funds provide the requested amount, the payment processor can prioritize between the different grants based on the size of total funding available by each philanthropic organization (e.g., selecting the organization with much larger funding than another organization with limited funds if the user qualifies for both organizations' grants). The payment processor can determine if the aggregate sum of approved funds available from all organizations willing to provide funds to the user meets the user's request amount.

At 560, in response to determining that the approved grant funds do not meet the estimated cost provided by the merchant, the payment processor can collect funds from individual contributors as described in the flow diagram of FIG. 5. For example, upon determining that the approved amount of funds is less than the estimated cost, the payment processor can initiate a process to collect a remaining amount of funds from individual contributors for the specified purpose in a virtual account associated with the specified purpose and a user of the user device, as described in steps 504-518 in the flow diagram of FIG. 5 and the associated description above. For example, the payment processor can transmit, to the user device, an incident ID associated with the request and a link to share with one or more individual contributors through which funds can be collected for the specified purpose in a virtual account associated with the specified purpose and the user. After fund collection has occurred, the method 600 can proceed to step 562 to determine if a payment request has been received from the merchant terminal within a predetermined time limit.

At 562, in response to determining that the approved grant funds do meet the estimated cost provided by the merchant, the payment processor can determine whether a payment request has been received within the predetermined time limit since the incident request was received from the user at 502. For example, the payment handling module 204 can determine whether a request from merchant server 208 to provide payment for the specified purpose occurs within a predetermined amount of time since the time of receipt of the request to collect funds from the user. The payment processor can be programmed to calculate such a predetermined amount of time based on the type of specified purpose. For example, the predetermined amount of time for medical treatments to an injury incurred with an accident can have shorter lengths of predetermined time periods than, for example, the request for tuition payments. If no such request has been received from the merchant within this predetermined amount of time, the method 600 can proceed to step 520 and refund all available funds in the virtual account to the original fund contributors. For example, if the patient 322 dies on the way to the hospital from the injury after having submitted the request to collect funds and the hospital 328 never charges the payment processor 320 for such treatment because the patient 322 died on the way to the hospital, after the predetermined time since the user request has lapsed, the payment processor 320 can refund the collected funds to the contributors. Similarly, if no payment request is received within a predetermined time from when the user request to collect funds was sent, no grant funds are withdrawn from the philanthropic organization.

At 564, in response to determining that payment request has been received from the merchant terminal within the predetermined amount of time since the user request was received at 552, the payment processor can request the user to authorize payment of the requested amount to the merchant. For example, in response to receiving such a payment request, the payment authorization engine 222 can send a query to the merchant-side processor 240 at the merchant server 208 to have the user enter their authorization code which was previously sent to the user and/or the user device at 554. The merchant server 208 can be associated with a kiosk and/or a device located at the merchant through which the user can enter their authorization code to authorize the merchant's request for payment to the payment handling module 204. In some other embodiments, in response to receiving a payment request from the merchant server 208, the payment authorization engine 222 can send a query to the user device 209 to have the user enter their authorization code instead of having the user enter the authorization code at the merchant kiosk and/or device associated with the merchant server 208.

At 566, the payment processor can determine whether payment was authorized by the user. For example, the payment authorization engine 222 can check the incident ID and the authorization code entered at the merchant kiosk that was transmitted by the merchant side-processor and compare that authorization code with the authorization code that the incident handling module 202 had sent to the user device 209 associated with the corresponding incident ID at the time of the user request to collect funds. If the authorization codes match, the payment processor can authorize payment to the merchant. If the authorization codes do not match, the method 600 can revert back to step 564 and the payment processor can query the merchant-side processor 240 to have the user enter their authorization code again correctly.

At 568, in response to determining that the user has authorized payment to the merchant for the requested amount, the payment processor can transmit a request to the philanthropic organization to provide the approved amount of funds to the merchant. For example, the payment processor 320 can instruct philanthropic organization 330 to transmit the approved amount of funds to the hospital 328. In some embodiments, the payment processor can instruct the philanthropic fund 248a-n to transmit the approved amount of funds for the user's incident to the merchant server 208.

At 570, the payment processor can refund the excess funds remaining in the virtual account to the fund contributors. Upon determining that there is a nonzero balance remaining in the patient 322's virtual account (e.g., account collecting funds contributed by individual contributors), the refund allocation engine 228 can provide each fund contributor 326a-c with a refund amount that is proportionate to the percentage of the total contribution (e.g. for the remaining balance of funds after all grant funding) made in the incident fund that was raised by that particular contributor's contribution. For example, if fund contributor 326a provided 20% of the total amount of individual contributor funds in the incident fund 232, the refund allocation engine 228 can refund 20% of that balance to contributor 326a.

FIG. 7 is a block diagram illustrating further details of a representative computer system according to an illustrative embodiment of the disclosed subject matter.

The systems and techniques discussed herein can be implemented in a computer system. As an example and not by limitation, as shown in FIG. 7, the computer system having architecture 600 can provide functionality as a result of processor(s) 601 executing software embodied in one or more tangible, non-transitory computer-readable media, such as memory 603. The software implementing various embodiments of the present disclosure can be stored in memory 603 and executed by processor(s) 601. A computer-readable medium can include one or more memory devices, according to particular needs. Memory 603 can read the software from one or more other computer-readable media, such as mass storage device(s) 635 or from one or more other sources via communication interface 620. The software can cause processor(s) 601 to execute particular processes or particular parts of particular processes described herein, including defining data structures stored in memory 603 and modifying such data structures according to the processes defined by the software. An exemplary input device 633 can be, for example, a keyboard, a pointing device (e.g., a mouse), a touchscreen display, a microphone and voice control interface, a pressure sensor or the like to capture user input coupled to the input interface 623 to provide data and/or user input to the processor 601. An exemplary output device 634 can be, for example, a display (e.g., a monitor) or speakers or a haptic device coupled to the output interface 624 to allow the processor 601 to present a user interface, visual content, and/or audio content. Additionally or alternatively, the computer system 600 can provide an indication to the user by sending text or graphical data to a display 632 coupled to a video interface 622. Furthermore, any of the above components can provide data to or receive data from the processor 601 via a computer network 630 coupled the communication interface 620 of the computer system 600. In addition or as an alternative, the computer system can provide functionality as a result of logic hardwired or otherwise embodied in a circuit, which can operate in place of or together with software to execute particular processes or particular parts of particular processes described herein. Reference to software or executable instructions can encompass logic, and vice versa, where appropriate. Reference to a computer-readable media can encompass a circuit (such as an integrated circuit (IC)) storing software or executable instructions for execution, a circuit embodying logic for execution, or both, where appropriate. The present disclosure encompasses any suitable combination of hardware and software.

In some embodiments, processor 601 includes hardware for executing instructions, such as those making up a computer program. As an example and not by way of limitation, to execute instructions, processor 601 can retrieve (or fetch) the instructions from an internal register, an internal cache 602, memory 603, or storage 608; decode and execute them; and then write one or more results to an internal register, an internal cache 602, memory 603, or storage 608. In particular embodiments, processor 601 can include one or more internal caches 602 for data, instructions, or addresses. This disclosure contemplates processor 601 including any suitable number of any suitable internal caches, where appropriate. As an example and not by way of limitation, processor 601 can include one or more instruction caches 602, one or more data caches 602, and one or more translation lookaside buffers (TLBs). Instructions in the instruction caches 602 can be copies of instructions in memory 603 or storage 608, and the instruction caches 602 can speed up retrieval of those instructions by processor 601. Data in the data caches 602 can be copies of data in memory 603 or storage 608 for instructions executing at processor 601 to operate on; the results of previous instructions executed at processor 601 for access by subsequent instructions executing at processor 601 or for writing to memory 603 or storage 608; or other suitable data. The data caches 602 can speed up read or write operations by processor 601. The TLBs can speed up virtual-address translation for processor 601. In some embodiments, processor 601 can include one or more internal registers for data, instructions, or addresses. This disclosure contemplates processor 601 including any suitable number of any suitable internal registers, where appropriate. Where appropriate, processor 601 can include one or more arithmetic logic units (ALUs); be a multi-core processor; or include one or more processors 601. Although this disclosure describes and illustrates a particular processor, this disclosure contemplates any suitable processor.

In some embodiments, memory 603 includes main memory for storing instructions for processor 601 to execute or data for processor 601 to operate on. As an example and not by way of limitation, computer system 600 can load instructions from storage 608 or another source (such as, for example, another computer system 600) to memory 603. Processor 601 can then load the instructions from memory 603 to an internal register or internal cache 602. To execute the instructions, processor 601 can retrieve the instructions from the internal register or internal cache 602 and decode them. During or after execution of the instructions, processor 601 can write one or more results (which can be intermediate or final results) to the internal register or internal cache 602. Processor 601 can then write one or more of those results to memory 603. In some embodiments, processor 601 executes only instructions in one or more internal registers or internal caches 602 or in memory 603 (as opposed to storage 608 or elsewhere) and operates only on data in one or more internal registers or internal caches or in memory 603 (as opposed to storage 608 or elsewhere). One or more memory buses (which can each include an address bus and a data bus) can couple processor 601 to memory 603. Bus 640 can include one or more memory buses, as described below. In particular embodiments, one or more memory management units (MMUs) reside between processor 601 and memory 603 and facilitate accesses to memory 603 requested by processor 601. In some embodiments, memory 603 includes random access memory (RAM). This RAM can be volatile memory, where appropriate. Where appropriate, this RAM can be dynamic RAM (DRAM) or static RAM (SRAM). Moreover, where appropriate, this RAM can be single-ported or multi-ported RAM. This disclosure contemplates any suitable RAM. Memory 603 can include one or more memories 604, where appropriate. Although this disclosure describes and illustrates particular memory, this disclosure contemplates any suitable memory.

In some embodiments, storage 608 includes mass storage for data or instructions. As an example and not by way of limitation, storage 608 can include a hard disk drive (HDD), a floppy disk drive, flash memory, an optical disc, a magneto-optical disc, magnetic tape, or a Universal Serial Bus (USB) drive or a combination of two or more of these. Storage 608 can include removable or non-removable (or fixed) media, where appropriate. Storage 608 can be internal or external to computer system 600, where appropriate. In some embodiments, storage 608 is non-volatile, solid-state memory. In some embodiments, storage 608 includes read-only memory (ROM). Where appropriate, this ROM can be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 608 taking any suitable physical form. Storage 608 can include one or more storage control units facilitating communication between processor 601 and storage 608, where appropriate. Where appropriate, storage 608 can include one or more storages 608. Although this disclosure describes and illustrates particular storage, this disclosure contemplates any suitable storage.

In some embodiments, input interface 623 and output interface 624 can include hardware, software, or both, providing one or more interfaces for communication between computer system 600 and one or more input device(s) 633 and/or output device(s) 634. Computer system 600 can include one or more of these input device(s) 633 and/or output device(s) 634, where appropriate. One or more of these input device(s) 633 and/or output device(s) 634 can enable communication between a person and computer system 600. As an example and not by way of limitation, an input device 633 and/or output device 634 can include a keyboard, keypad, microphone, monitor, mouse, printer, scanner, speaker, still camera, stylus, tablet, touch screen, trackball, video camera, another suitable input device 633 and/or output device 634 or a combination of two or more of these. An input device 633 and/or output device 634 can include one or more sensors. This disclosure contemplates any suitable input device(s) 633 and/or output device(s) 634 and any suitable input interface 623 and output interface 624 for them. Where appropriate, input interface 623 and output interface 624 can include one or more device or software drivers enabling processor 601 to drive one or more of these input device(s) 633 and/or output device(s) 634. Input interface 623 and output interface 624 can include one or more input interfaces 623 or output interfaces 624, where appropriate. Although this disclosure describes and illustrates a particular input interface 623 and output interface 624, this disclosure contemplates any suitable input interface 623 and output interface 624.

As embodied herein, communication interface 620 can include hardware, software, or both providing one or more interfaces for communication (such as, for example, packet-based communication) between computer system 600 and one or more other computer systems 600 or one or more networks. As an example and not by way of limitation, communication interface 620 can include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 620 for it. As an example and not by way of limitation, computer system 600 can communicate with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, computer system 600 can communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 can include any suitable communication interface 620 for any of these networks, where appropriate. Communication interface 620 can include one or more communication interfaces 620, where appropriate. Although this disclosure describes and illustrates a particular communication interface, this disclosure contemplates any suitable communication interface.

In some embodiments, bus 640 includes hardware, software, or both coupling components of computer system 600 to each other. As an example and not by way of limitation, bus 640 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 640 can include one or more buses 604, where appropriate. Although this disclosure describes and illustrates a particular bus, this disclosure contemplates any suitable bus or interconnect.

Herein, a computer-readable non-transitory storage medium or media can include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium can be volatile, non-volatile, or a combination of volatile and non-volatile, where appropriate.

The foregoing merely illustrates the principles of the disclosed subject matter. Various modifications and alterations to the described embodiments will be apparent to those skilled in the art in view of the teachings herein. It will thus be appreciated that those skilled in the art will be able to devise numerous techniques which, although not explicitly described herein, embody the principles of the disclosed subject matter and are thus within its spirit and scope.

1. A computer-implemented method for collecting funds, comprising:
receiving, at a payment processor and from a user device, a request to collect funds for a specified purpose;
transmitting, by the payment processor and to the user device, an authorization code for payment authorization; and
determining, by the payment processor, whether a user of the user device qualifies to receive, from at least one philanthropic organization, an approved amount of funds from at least one grant for the specified purpose based on one or more user attributes of the user and the specified purpose;
upon determining that the user qualifies to receive the at least one grant and in response to receiving a request from a merchant for payment:
determining, by the payment processor, that the merchant is requesting payment for the specified purpose;
requesting, by the payment processor, the user device to authorize payment to the merchant using the authorization code; and
transmitting, by the payment processor, a request to the philanthropic organization to provide the approved amount of funds to the merchant.

2. The computer-implemented method of claim 1, wherein the merchant is aware of a plurality of philanthropic organizations that provide grants based on specific eligibility criteria.

3. The computer-implemented method of claim 2, wherein determining that the user qualifies to receive the at least one grant further comprises:
identifying, by the payment processor, the at least one grant by performing at least one or more of:
comparing, by the payment processor, the one or more user attributes of the user against the specific eligibility criteria of each grant provided by the plurality of philanthropic organizations to determine which grants the user is eligible to be awarded; and
comparing, by the payment processor, the specified purpose indicated in the request to collect funds from the user device against the specific eligibility criteria of each grant provided by the plurality of philanthropic organizations to determine if there exist any grants to provide funds to the user for the specific purpose.

4. The computer-implemented method of claim 3, further comprising searching at least one or more databases identifying the plurality of philanthropic organizations and the specific eligibility criteria of each grant provided by each of the plurality of philanthropic organizations.

5. The computer-implemented method of claim 1, wherein the one or more user attributes of the user can be obtained by one or more of:
providing, by the payment processor, the user with questions to determine whether the user is a match for the specified criteria associated with different grants; and
obtaining, by the payment processor, user demographic information from one or more publicly available databases.

6. The computer-implemented method of claim 1, wherein the approved amount of funds can be used to pay merchants at one or more institutions that are associated with the specified purpose.

7. The computer-implemented method of claim 1, wherein the user is prevented from withdrawing the approved amount of funds.

8. The computer-implemented method of claim 1, further comprising
determining, by the payment processor, the approved amount of funds from at least one grant for the specified purpose meets an estimated cost provided by the merchant; and
upon determining that the approved amount of funds is less than the estimated cost, collecting, by the payment processor, a remaining amount of funds from individual contributors for the specified purpose in a virtual account associated with the specified purpose and a user of the user device.

9. The computer-implemented method of claim 8, wherein the collecting the remaining amount of funds further comprises:
transmitting, by the payment processor and to the user device, an authorization code for payment authorization and a link to share with one or more individual contributors through which funds can be collected for the specified purpose in a virtual account associated with the specified purpose and the user; and
in response to receiving a request from the merchant for payment, instructing, by the payment processor, a financial institution associated with the virtual account to transfer an amount of funds collected from the individual contributors for the remaining amount of funds in the virtual account to the merchant.

10. The computer-implemented method of claim 1, further comprising providing, by the payment processor, updates to the user device indicating that at least one grant is available from the at least one philanthropic organization for the specified purposed upon determining that the user qualifies to receive the at least one grant.

11. An apparatus for collecting funds, comprising:
a payment processor configured to communicate with a user device and a merchant-side processor, the payment processor configured to:
receive, from the user device, a request to collect funds for a specified purpose;
transmit, to the user device, an authorization code for payment authorization; and
determine whether a user of the user device qualifies to receive, from at least one philanthropic organization, an approved amount of funds from at least one grant for the specified purpose based on one or more user attributes of the user and the specified purpose;
upon determining that the user qualifies to receive the at least one grant and in response to receiving a request from the merchant-side processor for payment:
determine whether the merchant is requesting payment for the specified purpose;
request the user device to authorize payment to the merchant using the authorization code; and
transmit a request to the philanthropic organization to provide the approved amount of funds to the merchant.

12. The apparatus of claim 11, wherein the merchant-side processor has access to one or more databases identifying a plurality of philanthropic organizations that provide grants based on specific eligibility criteria.

13. The apparatus of claim 12, wherein the payment processor determines that the user qualifies to receive the at least one grant by being further configured to:
identify the at least one grant by performing at least one or more of:
comparing the one or more user attributes of the user against the specific eligibility criteria of each grant provided by the plurality of philanthropic organizations to determine which grants the user is eligible to be awarded; and
comparing the specified purpose indicated in the request to collect funds from the user device against the specific eligibility criteria of each grant provided by the plurality of philanthropic organizations to determine if there exist any grants to provide funds to the user for the specific purpose.

14. The apparatus of claim 13, wherein the payment processor is further configured to search at least one or more databases identifying the plurality of philanthropic organizations and the specific eligibility criteria of each grant provided by each of the plurality of philanthropic organizations.

15. The apparatus of claim 13, wherein the one or more user attributes of the user can be obtained by having the payment processor be further configured to perform one or more of:
providing the user with questions to determine whether the user is a match for the specified criteria associated with different grants; and
obtaining user demographic information from one or more publicly available databases.

16. The apparatus of claim 11, wherein the approved amount of funds can be used to pay merchants at one or more institutions that are associated with the specified purpose.

17. The apparatus of claim 11, wherein the user is prevented from withdrawing the approved amount of funds.

18. The apparatus of claim 11, wherein the payment processor is further configured to:
determine the approved amount of funds from at least one grant for the specified purpose meets an estimated cost provided by the merchant-side processor; and
upon determining that the approved amount of funds is less than the estimated cost, collect a remaining amount of funds from individual contributors for the specified purpose in a virtual account associated with the specified purpose and a user of the user device.

19. The apparatus of claim 18, wherein to collect the remaining amount of funds, the payment processor is further configured to:
transmit, to the user device, an authorization code for payment authorization and a link to share with one or more individual contributors through which funds can be collected for the specified purpose in a virtual account associated with the specified purpose and the user of the user device; and
in response to receiving a request from the merchant-side processor for payment, instruct a financial institution-side processor associated with the virtual account to transfer an amount of funds collected from the individual contributors for the remaining amount of funds in the virtual account to the merchant.

20. The apparatus of claim 11, wherein the payment processor is further configured to provide updates to the user device indicating that at least one grant is available from the at least one philanthropic organization for the specified purposed upon determining that the user qualifies to receive the at least one grant.
